(19) United States
(12) Patent Application Publication
(10) Pub. No.: US 2024/0014446 A1
(43) Pub. Date: Jan. 11, 2024

(54) Sulfonyl-Based Electrolyte Solvents, Electrolytes Made Therewith, and Electrochemical Devices Made Using Such Electrolytes

(71) Applicant: SES Holdings Pte. Ltd., Singapore (SG)

(72) Inventors: Bin Liu, Lexington, MA (US); Shubha Nageswaran, Billerica, MA (US); Ke Sun, Woburn, MA (US); Jinyu Du, Cambridge, MA (US); Rajendra Singh, Woburn, MA (US); Hong Gan, Woburn, MA (US); Qichao Hu, Arlington, MA (US)

(21) Appl. No.: 18/025,559

(22) PCT Filed: May 25, 2021
(86) PCT No.: PCT/IB2021/054540

§ 371 Date: Mar. 9, 2023

Related U.S. Application Data
(60) Provisional application No. 63/162,634, filed on Mar. 18, 2021.
(60) Provisional application No. 63/106,467, filed on Oct. 28, 2020.
(60) Provisional application No. 63/077,305, filed on Sep. 11, 2020.

(51) Int. Cl. H01M 10/0569

(52) U.S. Cl. CPC H01M 10/0569; H01M 2300/0037; H01M 2300/0034

(57) ABSTRACT

Sulfonyl-based solvent systems for electrolytes used in electro-chemical devices, such as secondary batteries. In some embodiments, a solvent system of the disclosure includes a sulfonyl (—SO₂—)-based solvent optionally in combination with one or more different sulfonyl-based solvents and/or one or more non-sulfonyl-based solvents. Five example chemical structures for a sulfonyl-based solvent usable in a sulfonyl-based solvent system of this disclosure are disclosed. Also disclosed are electrolytes that include one or more salts, such as one or more alkali-metal salts, dissolved in a sulfonyl-based solvent system of the present disclosure. Proper formulation of a disclosed electrolyte can lead to one or more benefits, including but not limited to, improved cycle life, improved low-temperature operation, and reduced flammability.

### RELATED APPLICATION DATA

This application claims the benefit of priority of U.S. Provisional Patent Application Ser. No. 63/077,305, filed Sep. 11, 2020, and titled “Class of Sulfonyl-Type Electrolyte Solvents, and Electrolytes Made Therewith and Electrochemical Devices Made Using Such Electrolytes”, U.S. Provisional Patent Application Ser. No. 63/106,467, filed Oct. 28, 2020, and titled “Class of Sulfonyl-Type Electrolyte Solvents, and Electrolytes Made Therewith and Electrochemical Devices Made Using Such Electrolytes”, and U.S. Provisional Patent Application Ser. No. 63/162,634, filed Mar. 18, 2021, and titled “Class of Sulfonyl-Type Electrolyte Solvents, and Electrolytes Made Therewith and Electrochemical Devices Made Using Such Electrolytes”, each of which is incorporated by reference herein in its entirety.

### FIELD OF THE INVENTION

The present invention generally relates to the field of electrolytes for electrochemical devices. In particular, the present invention is directed to sulfonyl-based electrolyte solvents, electrolytes made therewith, and electrochemical devices made using such electrolytes.

### BACKGROUND

In light of low Coulombic efficiency (CE) of Li plating/stripping, progressive growth of lithium dendrite, and poor cycle life of high energy Li metal batteries (LMBs) based on conventional existing electrolytes, some success in new electrolyte discovery will be desired. Even with the high oxidative stability towards cathode of up to 4.5 V, traditional carbonate-based electrolyte initially designed for Li-ion batteries does not work well with lithium-metal-anode rechargeable batteries due to the severe lithium dendrite formation during lithium metal deposition/stripping cycling. Highly concentrated salt carbonate-based electrolyte improves the lithium deposition morphology but is still undesirable due to its high reductive reactivity towards the lithium metal anode, resulting in low lithium metal cycling CE and short cycle life. Ether-based electrolyte exhibits better chemical stability towards lithium metal, and highly concentrated ether-based electrolyte, including the ether-based localized highly concentrated electrolyte, expands ether's oxidative electrochemical stability window up to 4.3V to enable significantly improved cycle life for the 4V lithium metal rechargeable batteries. However, ether-based electrolyte has inherent weakness due to the low oxidative stability of the ether functional group, which can be oxidized easily as uncoordinated solvent at the high voltage (>3.5 V) cathode surface, especially at high temperature (>45° C.), leading to the excess cell impedance growth and causing the cell failure. Both the commonly reported carbonate-based electrolyte system and ether-based electrolyte system have drawbacks and limitations for lithium metal rechargeable battery applications.

How to enhance thermodynamic/kinetic stability towards Li anode and oxidative stability at high voltage of next-generation electrolytes in LMBs is challenging but of importance, which directly associates with further development of high energy LMBs for a span of various applications, especially in electric vehicles (EVs). Therefore, finding an alternative electrolyte solvent system which is compatible with and effectively passivate lithium metal anode and at the same time oxidatively stable at the high voltage cathode (>4V) is desirable for achieving lithium metal anode cell long cycle life.

When compared to various known solvents (e.g., typical carbonate- and ether-solvents) for rechargeable LMBs, a theoretically new class of sulfonyl solvents is capable of better anti-oxidation performance at higher voltages during battery charging and has more efficient passivation capability towards the Li metal anode. Recently, an electrolyte composed of LiFSI and LiPF6 salts and a single N,N-dimethylsulfamoyl fluoride (DSF) solvent was reported to improve battery cycling. However, the reported Coulombic efficiency (99.03%) of Li plating/stripping in the LMB obtained with this single sulfonyl-based electrolyte is still not satisfactory. In addition, there are some undesired properties of DSF itself, such as poor coordination power with most salts facilitating high solvent volatility, not very satisfied oxidation stability, high melting point causing limited low temperature performance, high cost due to high concentration salt dissolved, high viscosity, and no fire-retardancy, among other things.

### SUMMARY OF THE DISCLOSURE

In one implementation, the present disclosure is directed to an electrolyte for an electrochemical device having an alkali-metal anode having an anode-active material comprising an alkali metal. The electrolyte includes a sulfonyl-based solvent system comprising one or more sulfonyl-based solvents, each having one of the following general molecular structures: Structure 1: R₁—SO₂—R₂, wherein: each of R₁ and R₂ is any one of: —F; —CF₃; —N(SO₂F)2; —N(CH₃)SO₂F, —N[(CH₂)ₓCH₃)][(CH₂)_{y}CH₃)] (x=0 to 3, y=0 to 3); —N[(CH₂)ₓCH₃][(CH₂)_{y}CH═CH(CH₂)_{z}—H] (x=0 to 2; y=1 to 3, z=0 to 3); —(CH₂)ₓCH═CH(CH₂)_{y}—H (x=0 to 3; y=0 to 3); —C₆H₅₋ₓF_{X}(x=0 to 5); —(CH₂)ₓ(CH_{2-y}F_{y})_{z}CH₃₋₂F_{w} (x=0 to 2, y=1 to 2, z=0 to 2, w=0 to 3); —(CH₂)ₓ(CH_{2-y}F_{y})_{z}F (x=0 to 2, y=0 to 2, z=0 to 2); and —(CH₂)ₓCH═CH(CH_{2-y}F_{y})_{z}F (x=0 to 3, y=0 to 2, z=0 to 2); and R₁≠R₂ or R₁=R₂; Structure 2: —R₃—SO₂N—R₅SO₂—R₄—, wherein: each of R₃ and R₄ is any one of: —CF₂; —CH₂—: —CH((CH₂)ₓH₁₋₇F_{y})— (x=0 to 3, y=0 to 1); —CF((CH₂)ₓH_{1-y}F_{y})— (x=0 to 3, y=0 to 1); and —CH((CH₂₋ₓFₓ)_{y}CH═CH_{1-z}F_{z}(CH_{2-x′}F_{x′})ᵥH_{1-w}F_{w})— (x=0 to 2, x′=0 to 2, y=0 to 2, z=0 to 1, v=0 to 2, w=0 to 1); R₃≠R₄ or R₃=R₄; and R₅ is any one of: —(CH₂)ₓCH₃ (x=0 to 3); and —(CH₂)ₓCH═CH₂ (x=1 to 3); Structure 3: —R₆—SO₂N—(R₈)R₇—, wherein: each of R₆ and R₇ is any one of: —CF₂—; —CH₂—: —CH((CH₂)ₓH_{1-y}F_{y})— (x=0 to 3, y=0 to 1); —CF((CH₂)ₓH_{1-y}F_{y})— (x=0 to 3, y=0 to 1); and —CH((CH₂₋ₓFx)CH═CH_{1-z}F_{z}(CH₂₋ₓFₓ)ᵥH_{1-w}F_{w})— (x=0 to 2, x′=0 to 2, y=0 to 2, z=0 to 1, v=0 to 2, w=0 to 1); R₆≠R₇ or R₆=R₇; and R₈ can be any one of: —(CH₂)ₓCH₃ (x=0 to 3); and —(CH₂)ₓCH═CH₂ (x=1 to 3); Structure 4: R₉—SO₂N—(R₁₀)(R₁₁), wherein: R₉ can be —(CH₂)ₓ(CH_{2-y}F_{y})_{z}F (x=0 to 2, y=0 to 2, z=0 to 2), R₁₀ can be —(CH₂)ₓO(CH₂)_{y}CH₃ (x=2 to 4, y=0 to 2), R¹¹ can be —(CH₂)ₓCH₃ (x=0 to 3) or —(CH₂)ₓO(CH₂)_{y}CH₃ (x=2 to 4, y=0 to 2); R₁₀≠R₁₁ or R₁₀=R₁₁; and Structure 5: R₁₂—SO₂—R₁₃, wherein: within R₁₃ is a nitrogen (N)-containing, an oxygen (O)-containing, an only-hydrocarbon-containing, or an (N+O)-mixture-containing ring structure; R₁₂ is —(CH₂)ₓ(CH_{2-y}F_{y})_{z}F (x=0 to 2, y=0 to 2, z=0 to 2); R₁₃ is any one of: —N(CH₂)₄ (1-pyrrolidino five membered ring); —N(CH₂)₅ (1-piperidinyl six-membered ring); —N(CH₂CH₂)₂O (4-morpholinyl six-membered ring); —C₅H₉ (cyclopentane); —C₆H₁₁ (cyclohexane); —C₄H₇O (2 or 3-tetrahydrofuran); and a fluorinated analog thereof; and at least one alkali-metal salt dissolved in the one or more sulfonyl-based solvents, the alkali-metal salt having a cation comprising the alkali metal of the anode-active material; wherein, when the electrolyte contains a single solvent and the single solvent has Structure 1, Structure 1 does not include R₁ and R₂ being —N(CH₃)₂ in combination with either —F or —CF₃.

In another implementation, the present disclosure is directed to an electrolyte for an electrochemical device having an alkali-metal anode having an anode-active material comprising an alkali metal. The electrolyte includes a hybrid sulfonyl-based solvent system comprising: a first solvent that is a first sulfonyl-based solvent; and a second solvent selected from the group consisting of a second sulfonyl-based solvent and a non-sulfonyl-based solvent; and at least one alkali-metal salt dissolved in the hybrid sulfonyl-based solvent system, the alkali-metal salt having a cation comprising the alkali metal of the anode-active material.

### BRIEF DESCRIPTION OF THE DRAWINGS

For the purpose of illustrating embodiments of the disclosure, the drawings show aspects of one or more embodiments described herein. However, it should be understood that the present invention(s) is/are not limited to the precise arrangements and instrumentalities shown in the drawings, wherein:

FIG. 1A is a graph of capacity retention versus cycle number illustrating higher cycling stability of an anode-free pouch cell using an electrolyte containing a hybrid sulfonyl-based solvent system of the present disclosure versus the cycling stability of anode-free pouch cells using electrolytes containing non-hybrid sulfonyl-based solvent systems;

FIG. 1B is a graph of coulombic efficiencies of the anode-free pouch cells represented in FIG. 1A;

FIG. 2A is a graph of capacity retention versus cycle number for pouch cells comprising a lithium-metal anode an Li/NMC₈₁₁ cathode, with one pouch cell using an electrolyte containing a hybrid sulfonyl-based solvent system of the present disclosure and another pouch cell using an electrolyte containing a non-hybrid sulfonyl-based solvent system;

FIG. 2B is a graph of coulombic efficiency versus cycle number for the pouch cells of FIG. 2A;

FIG. 2C is a graph of charge capacity versus cycle number for the pouch cells of FIG. 2A;

FIG. 3 is a hybrid graph illustrating salt-solvent mole ratio versus volume ratio and salt molarity versus volume ratio for an electrolyte containing a hybrid sulfonyl-based solvent system composed of LiFSI and DFS and EMSF under the salt solubility upper limit at 10° C.;

FIG. 4 is graph of heat flow versus temperature from differential scanning calorimetry of a number of electrolytes that include a DFS-EMSF hybrid sulfonyl-based solvent system of the present disclosure and one electrolyte that contains DFS only as the solvent system;

FIG. 5 is a graph of current density versus potential from a linear-sweep voltammetry (LSV) scan for an ether-based electrolyte and a sulfonyl-based electrolyte illustrating the lower oxidative current density of the sulfonyl-based electrolyte at higher temperatures and high voltages relative to the ether-based electrolyte;

FIG. 6 is a graph of current density versus potential from an LSV scan for a hybrid sulfonyl-based electrolyte and a single sulfonyl-based electrolyte, illustrating the superior oxidative stability of the hybrid sulfonyl-based electrolyte relative to the single sulfonyl-based electrolyte;

FIG. 7 is a graph of current versus voltage from cyclic voltammetry (CV) with an aluminum electrode for the ether-based and sulfonyl-based electrolytes of FIG. 5, illustrating the passivation of the aluminum electrode after one cycle for both of the electrolytes; and

FIG. 8 is a graph of current versus voltage from CV with an aluminum electrode for the hybrid sulfonyl-based and a single sulfonyl-based electrolytes of FIG. 6, illustrating faster passivation of the aluminum electrode by the hybrid sulfonyl-based electrolyte than by the single sulfonyl-based electrolyte.

### DETAILED DESCRIPTION

In the context of lithium-metal batteries, a key technical problem is limited cycle life that is attributable to low coulombic efficiency (CE) of the lithium anode in most conventional electrolytes during cycling. In addition, some conventional electrolytes are stable against the lithium-metal anode but are oxidatively unstable towards 4V cathode materials, especially at temperatures higher than room temperature (˜20° C.). Some conventional electrolytes can maintain in liquid phase and be conductive at room and higher temperatures (e.g., >45° C.), but they do not work well at low temperatures (e.g., <0° C.) due to phase separation and freezing.

To solve these and other problems, new sulfonyl-based electrolytes disclosed herein can exhibit fewer side reactions with lithium, cause decreased lithium-deposition surface area, significantly increase CE of lithium plating/stripping, suppress lithium dendrite growth, minimize oxidative decomposition of the solvent(s) at high voltage (>4.5V) and high temperatures (>45° C.), and expand liquid state temperature range, singly and in various combinations with one another, so as to provide significant improvement in cycle life and high/low temperature stability. Cycling stability of the new sulfonyl-based electrolytes has been verified in different testing protocols, as well. By combining the presently disclosed new class of sulfonyl-based solvent systems with electrolyte formulation design, lithium-metal cells and batteries relying on these new sulfonyl-based solvent systems have demonstrated long-lasting cycles, high energy density, and improved safety.

Before proceeding with more-detailed descriptions, it is noted that throughout the present disclosure, the term “about”, when used with a corresponding numeric value, refers to ±20% of the numeric value, typically ±10% of the numeric value, often ±5% of the numeric value, and more often ±2% of the numeric value. In some embodiments, the term “about” can mean the numeric value itself.

In some aspects, the present disclosure is directed to sulfonyl-based solvent systems for use in electrochemical devices, such as primary and secondary batteries and supercapacitors, among others. Sulfonyl-based solvent systems of the present disclosure are especially effective when used in secondary alkali-metal metal batteries (AMMBs), such as lithium-metal batteries (LMBs), in which the anodes are of a non-intercalating type and include alkali metal (e.g., lithium (Li), sodium (Na), potassium (K)), or an alloy thereof, as the anode-active material.

In the context of the present disclosure and the appended claims, the term “sulfonyl-based solvent” and like terms means that the solvent contains molecules that each include at least one sulfonyl (—SO₂—) group, each with a double bond between each oxygen atom and the sulfur atom (O═S═O), along with two substituents, Rₙ (n=2), and optionally a nitrogen atom bonded to at least one of the SO₂ groups. In some embodiments, a sulfonyl-based solvent system of the present disclosure includes a single sulfonyl-based solvent, with or without one or more non-sulfonyl-based solvents. In some embodiments, a single-sulfonyl-based solvent system may include a modified molecular structure of a conventional, commercially available sulfonyl-based solvent, such as N,N-dimethylsulfamoyl fluoride (C₂H₆FNO₂S, DSF). In some embodiments, a sulfonyl-based solvent system of the present disclosure includes two or more sulfonyl-based solvents of the present disclosure, with or without one or more non-sulfonyl-based solvents. It is noted that when a sulfonyl-based solvent system includes two or more sulfonyl-based solvents of the present disclosure, such as solvent system is described herein as being a “hybrid sulfonyl-based solvent system”. Detailed examples of chemical structures of sulfonyl-based solvents of the present disclosure are presented below.

In some aspects, the present disclosure is directed to electrolytes made using sulfonyl-based solvent systems of the present disclosure, and these electrolytes are referred to herein and in the appended claims as “sulfonyl-based electrolytes” for convenience. A sulfonyl-based electrolyte of the present disclosure includes a sulfonyl-based solvent system of the present disclosure, one or more salts suitable for the intended electrochemical device, and, optionally, one or more other components, such as one or more additives added to improve one or more properties or characteristics of the sulfonyl-based electrolyte. In the context of AMMBs, each salt will typically include the relevant alkali metal(s) as the cations. Non-exhaustive examples of salts and salt combinations for use in a sulfonyl-based electrolyte of the present disclosure appear below.

Benefits for AMMBs, including LMBs, that arise from using a sulfonyl-based electrolyte of the present disclosure include the following, individually and/or in various combinations with one another, depending on the circumstances at issue. A sulfonyl-based electrolyte of the present disclosure can have an extremely high stability (e.g., an alkali-metal (e.g., Li) plating/stripping coulombic efficiency (CE) >about 99.0% or even >about 99.5% or higher) towards the alkali-metal anode (e.g., Li-metal anode) and a high antioxidation capability (e.g., oxidation voltage >about 4.3V or even >about 4.8V), which can lead to improved cycling performance relative to AMMBs, including LMBs, utilizing only conventional non-sulfonyl-based solvent systems. Through molecular design of a new class of sulfonyl-based solvents as disclosed herein, newly discovered sulfonyl-based electrolytes containing a single sulfonyl-based solvent system or a hybrid sulfonyl-based solvent system can deliver very high chemical and electrochemical stability at the cathode and anode in an AMMB, such as an LMB, enhanced wide-temperature performance, nonflammability performance, low cost, high safety, and good compatibility with cell manufacturing and processing. While sulfonyl-based electrolytes of the present disclosure are particularly useful for AMMBs, their uses are not limited thereto.

As noted above, in some embodiments, a sulfonyl-based solvent of the present disclosure may include a modified version of DSF. For example, one pathway to improve the oxidative stability of DSF is to replace the electron-donating amine group, —N(CH₃)₂, in DSF with an organic group that has less electron donating ability, such as a saturated or unsaturated hydrocarbon group (e.g., alkyl, alkene, alkyne or aromatic group, with or without fluoro-substituents), replacing at least one of the methyl groups with an electron-withdrawing substituent (e.g., a fluoro-substituted alkyl group, oxyalkyl group), etc. As an example, the melting point of DSF can be lowered by replacing the symmetric —N(CH₃)₂ amine group in DSF with a nonsymmetric group, such as the —N(CH₃)(CH₂CH₃) group, resulting in N-ethyl, N-methyl sulfamoyl fluoride (EMSF) and reducing the melting point from −16° C. for DSF to −65° C., or, for example, by replacing the —N(CH₃)₂ group in DSF with a longer hydrocarbon-based substituent, such as —N(CH₂CH₃)₂, resulting in diethylsulfamoyl fluoride (DESF) and reducing the melting point from −16° C. for DSF to −35° C. Moreover, bis(2-methoxyethyl) sulfamoyl fluoride (BMSF) obtained by replacing two methyl groups on —N with two methoxyethyl groups has enhanced boiling point (290° C.) and low melting point (−37° C.), which benefits to have wide operating temperature range of BMSF-containing electrolyte.

The interaction between a sulfonyl-based electrolyte of the present disclosure and an alkali-metal anode of an AMMB, such as a lithium-metal anode of an LMB, forms a solid electrolyte interphase (SEI) layer on the alkali-metal anode to protect the alkali metal during battery operation, similarly to conventional electrolytes forming SEI layers. A similar cathode electrolyte interphase (CEI) layer can likewise form on the cathode of the AMMB. To further improve the stability of the SEI layer and/or the CEI layer, an unsaturated organic group that can be a precursor for forming organic polymers in combination with the inorganic component that forms on the electrolyte/electrode interfaces may be introduced into the structure of the sulfonyl-based solvent. For example, the ethene (═CH₂) in ethenesulfonyl fluoride (C₂H₃SO₂F, ESF) can be such an unsaturated organic group.

As also noted above, some embodiments of the present disclosure involve hybrid sulfonyl-based solvent systems that include a mixture of two or more of sulfonyl-based solvents. Synergetic effects of using hybrid sulfonyl-based solvent systems have been observed in sulfonyl-based electrolytes using such systems. For example, using a hybrid sulfonyl-based solvent system allows for interaction of the multiple sulfonyl-based solvents with one or more salts in the electrolyte, and such interaction can result in different (relative to conventional solvent systems and/or single-sulfonyl-based solvent systems) and/or novel: salt-solvent solvation structures; salt solubility; physical/chemical/ electrochemical properties in both bulk electrolyte and on the solid-electrolyte interface. Such different and/or novel aspects of a hybrid sulfonyl-based solvent system of the present disclosure can result in superior overall cell performance that cannot be achieved with either a single-sulfonyl-based solvent system or a conventional solvent system. Example hybrid sulfonyl-based solvent systems include DSF +ESF and DSF +EMSF, among others.

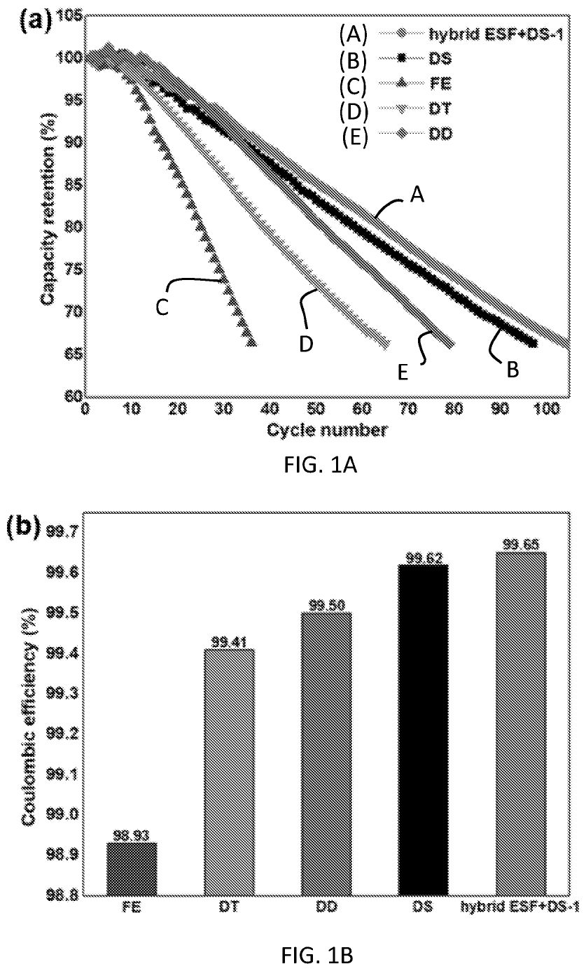

In one example, a sulfonyl-based electrolyte of the present disclosure includes lithium bis(fluorosulfonyl)imide (F₂LiNO₄S₂, LiFSI) salt dissolved in a hybrid mixture of ESF and DSF (“hybrid ESF+DS-1” in FIGS. 1A and 1B), specifically, 2.0 M LiFSI in (ESF (0.25 mol %)+DSF (99.75 mol %)). As shown in FIGS. 1A and 1B, this example electrolyte achieved higher electrochemical stability (FIG. 1A) and CE (FIG. 1B) in anode-free pouch cells (Cu/LiNi_{0.8}Mn_{0.1}Co_{0.1}O₂ (Cu/NMC₈₁₁)) than each of: an aforementioned single DSF-based electrolyte (“DS”: 2.5 M LiFSI in DSF); a traditional carbonate-based electrolyte (“FE”: 2.5 M LiFSI in fluoroethylene carbonate (FEC) and ethylmethyl carbonate (EMC) in a ratio of 3:7 v:v)); and optimized ether electrolytes (“DD”: 3.97 M LiFSI in 1,4-dioxane (DX) and DEE in a ratio of 1:5.1 v:v +30% 1,2-(1,1,2,2-Tetrafluoroethoxy)ethane (TFE) and “DT”: 3.6M LiFSI in ethylene glycol diethyl ether (DEE)+40% TFE). These cells were cycled under C/3—C/3 rate at room temperature (20° C. to 25° C.) between 4.3V and 2.5V.

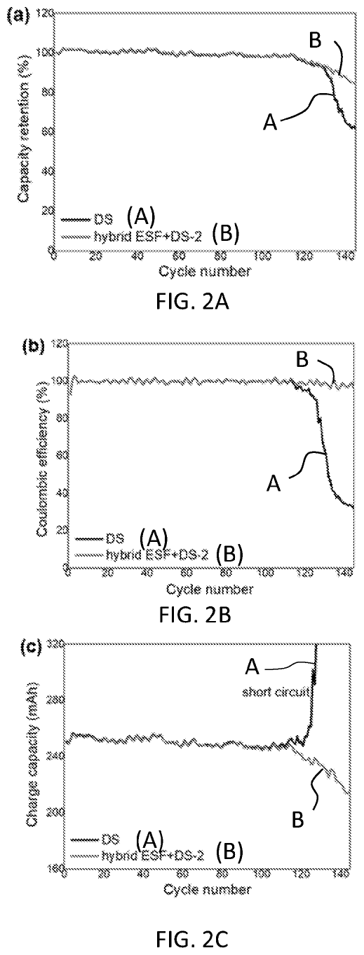

Referring to FIGS. 2A-2C, these figures illustrate cycling performance of 0.87Ah pouch cells that include a lithium-metal anode and an LiNi0.8Mn_{0.1}Co_{0.1}O₂ (LiNMC₈₁₁) cathode using, respectively, a sulfonyl-based electrolyte composed of a 2.5 M LiFSI solution in a hybrid sulfonyl-based solvent of ESF (0.25 mol %)/DSF (99.75 mol %) (“hybrid ESF+DS-2” in FIGS. 2A-2C) and a sulfonyl-based electrolyte composed of a 3.4 M LiFSI solution in DSF (100 mol %) (“DS”). FIGS. 2A-2C demonstrate that hybrid ESF-DSF sulfonyl-based electrolytes of the present disclosure are able to better improve cycling stability (FIGS. 2A and 2B) and inhibit short circuiting of cells during cycling (FIG. 2C) when compared with a DSF-only electrolyte.

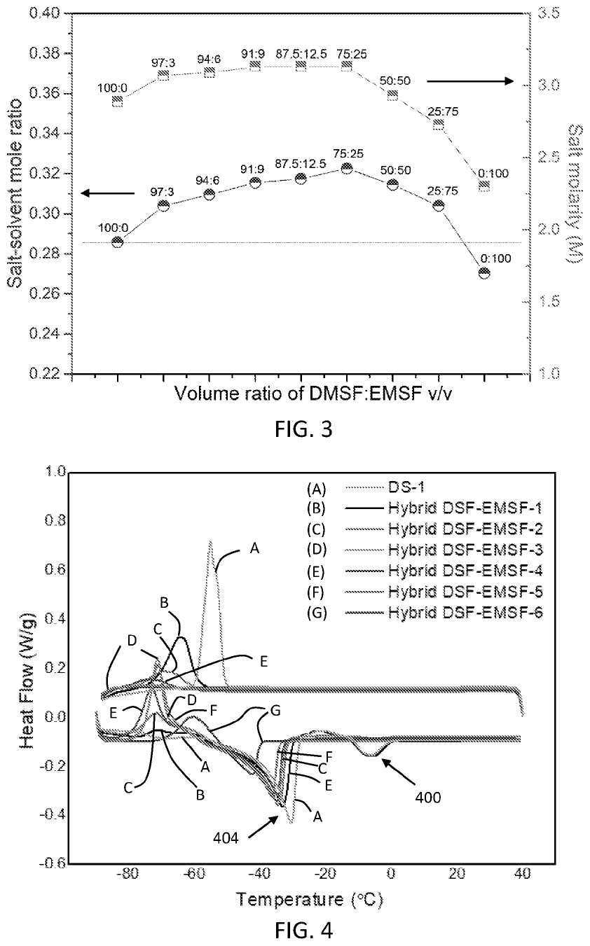

A further example of a hybrid sulfonyl-based solvent system and corresponding sulfonyl-based electrolyte is based on a hybrid mixture of DSF and EMSF. FIG. 3 illustrates results of a systematic investigation of LiFSI salt solubility in DSF-EMSF-based electrolytes. The studied electrolytes are listed below in the TABLE.

TABLE

| | LiFSI | Volume Percentage | Weight percentage | Mole percentage |
|---|---|---|---|---|
| | Salt | of DSF | of DSF | of DSF |
| Electrolyte | Concentration | Solvent:EMSF | Solvent:EMSF | Solvent:EMSF |
| Code | (M) | Solvent | Solvent | Solvent |
| DS-1 | 2.90 | 100.0%:0.0% | 100.0%:0.0% | 100.0%:0.0% |
| Hybrid DSF- | 3.07 | 97.0%:3.0% | 97.1%:2.9% | 97.4%:2.6% |
| EMSF-1 | | | | |
| Hybrid DSF- | 3.09 | 94.0%:6.0% | 94.3%:5.7% | 94.8%:5.2% |
| EMSF-2 | | | | |
| Hybrid DSF- | 3.11 | 92.5%:7.5% | 92.8%:7.2% | 93.5%:6.5% |
| EMSF-3 | | | | |
| Hybrid DSF- | 3.13 | 91.0%:9.0% | 91.4%:8.6% | 92.2%:7.8% |
| EMSF-4 | | | | |
| Hybrid DSF- | 3.13 | 87.5%:12.5% | 88.0%:12.0% | 89.0%:11.0% |
| EMSF-5 | | | | |
| Hybrid DSF- | 3.13 | 75.0%:25.0% | 75.9%:24.1% | 77.8%:22.2% |
| EMSF-6 | | | | |
| Hybrid DSF- | 2.93 | 50.0%:50.0% | 51.2%:48.8% | 53.6%:46.4% |
| EMSF-7 | | | | |
| Hybrid DSF- | 2.73 | 25.0%:75.0% | 25.9%:74.1% | 27.6%:72.4% |
| EMSF-8 | | | | |
| EM-1 | 2.30 | 0.0%:100.0% | 0.0%:100.0% | 0.0%:100.0% |

The investigation revealed that each of the hybrid DSF-EMSF sulfonyl-based electrolytes in the above TABLE unexpectedly demonstrated superior LiFSI salt solubility capability than the single solvent-based electrolyte systems in the TABLE, namely, “DS-1” (2.9 M LiFSI in only DSF) and “EM-1” (2.3 M LiFSI in only EMSF). This result confirms that hybrid sulfonyl-based solvent systems of the present disclosure are capable of greatly improve Li-salt solubility in them at room temperature without phase separation or salt deposition at 10° C., allowing them to break the Li-salt-solubility bottleneck of a single-solvent electrolyte (Li salt max solubility in DS-1 and EM-1 are 2.9 M and 2.3 M, respectively) (FIG. 3). This brings a considerable benefit in the form of electrochemical stability improvement. Addition of EMSF into DSF can change the solvation energy of two solvents EMSF and DSF with Li salt—LiFSI and coordination ratio of EMSF/DSF with LiFSI. Thus this Li salt solubility enhancement is attributed to synergistic interaction/effect in hybrid sulfonyl electrolytes, rather than single solvent-containing electrolytes.

FIG. 4 shows differential scanning calorimetry (DSC) data for the “Hybrid DSF-EMSF-1”, “Hybrid DSF-EMSF-2”, “Hybrid DSF-EMSF-3”, “Hybrid DSF-EMSF-4”, “Hybrid DSF-EMSF-5”, and “Hybrid DSF-EMSF-6” sulfonyl-based electrolytes of the TABLE above, as well as the “DS-1” electrolyte of that TABLE. FIG. 4 shows that there is one clear peak 400 located at −5° C., which indicates the existence of phase transition of the three electrolytes, “DS-1”, “Hybrid DSF-EMSF-1”, and “Hybrid DSF-EMSF-2”, having that peak, but surprisingly this phase transition peak at −5° C. goes away completely when the EMSF solvent component increases to 7.5% or higher content, by volume, of the hybrid sulfonyl-based solvent system. Another peak 404 located at −30° C. to −40° C. also gradually shifts to a lower phase-transition-temperature region as the amount of the EMSF solvent in the hybrid sulfonyl-based solvent system increases from 0% to 25%, by volume. In the example sulfonyl-based electrolytes illustrated in FIG. 4, 7.5%, by volume, of the EMSF solvent in the hybrid sulfonyl-based solvent systems is the turning point for this phase transition feature. These results demonstrate that sulfonyl-based electrolytes with a DSF-EMSF hybrid sulfonyl-based solvent system having 7.5% or more EMSF, by volume, extend the electrolyte temperature range of the liquid phase on the lower end, significantly improving the low-temperature properties of the discovered electrolytes. These enhanced low-temperature properties are beneficial, for example, for battery applications that require low-temperature operation. These results also confirm that considerable synergistic effects arise as a result of competitive coordination/binding ways of DSF and EMSF with salt that dominate chemical and electrochemical properties of newly discovered sulfonyl-based electrolytes of the present disclosure.

A sulfonyl-based solvent system, and/or a corresponding sulfonyl-based electrolyte, of the present disclosure contains at least one sulfonyl-based solvent having any of the following general chemical structures:

Structure 1:

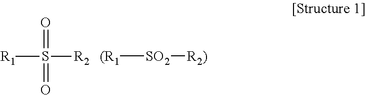

wherein:
each of R₁ and R₂ may be:
   —F;
   —CF₃;
   —N(SO₂F)₂;
   —N(CH₃)SO₂F, —N[(CH₂)ₓCH₃)][(CH₂)_{y}CH₃)] (x=0 to 3, y=0 to 3);
   —N[(CH₂)ₓCH₃][(CH₂)_{y}CH═CH(CH₂)_{z}—H] (x=0 to 2; y=1 to 3, z=0 to 3);
   —(CH₂)ₓCH═CH(CH₂)_{y}—H (x=0 to 3; y=0 to 3);
   —C₆H₅₋ₓFₓ (x=0 to 5);
   —(CH₂)ₓ(CH_{2-y}F_{y})_{z}CH_{3-w}F_{w} (x=0 to 2, y=1 to 2, z=0 to 2, w=0 to 3);
   —(CH₂)ₓ(CH_{2-y}F_{y})_{z}F (x=0 to 2, y=0 to 2, z=0 to 2); and
   —(CH₂)ₓCH═CH(CH_{2-y}F_{y})F (x=0 to 3, y=0 to 2, z=0 to 2); and
R₁≠R₂ or R₁=R₂.

Without limitation, following are example sulfonyl-based solvents having general Structure 1: 1) Ri is —CH═CH₂, R₂ is —F, and the solvent is CH₂=CHSO₂F; 2) R₁ is —CH═CH₂, R₂ is —CF₃, and the solvent is CH₂=CHSO₂CF₃; 3) R₁ is —N(CH₃)₂, R₂ is —F, and the solvent is (CH₃)₂NSO₂F; 4) R₁ is —NCH₃SO₂F, R₂ is F, and the solvent is FSO₂N(CH₃)SO₂F; 5) R₁ is —N(CH₃)(CH₂CH═CH₂), R₂ is —N(CH₃)₂, and the solvent is (CH₃)(CH₂=CHCH₂)NSO₂N(CH₃)₂; 6) R₁ is —CH═CHCH₃, R₂ is —N(CH₃)(CH₂CH₃), and the solvent is CH₃CH═CHSO₂N(CH₃)(CH₂CH₃); 7) R₁ is —C₆H₄F, R₂ is —CH₂CF₃, and the solvent is C₆H₄FSO₂CH₂CF₃; 8) R₁ is —CH₂F, R₂ is —CH═CHCH₂F, and the solvent is FCH₂SO₂CH═CHCH₂F; 9) R₁ is —CF₂CHCH═CHCH₂F, R₂ is —N(SO₂F)₂, and the solvent is CH₂FCH═CHCF₂SO₂N(SO₂F)₂; 10) R₁ is —C₆H₅, R₂ is F, and the solvent is C₆H₅SO₂F; 11) R₁ is F, R₂ is N(CH₃)(CH₂CH₃), and the solvent is FSO₂N(CH₃)(CH₂CH₃); 12) R₁ is F, R₂ is N(CH₂CH₃)₂, and the solvent is FSO₂N(CH₂CH₃)₂; and 13) R₁ is CF₃, R₂ is F, and the solvent is CF₃SO₂F.

Example structures of the foregoing examples of Structure 1:

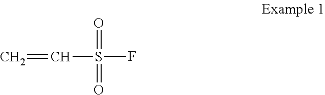

Structures 2 and 3:

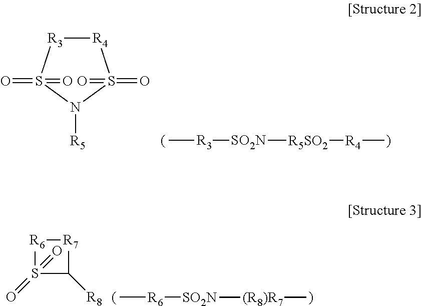

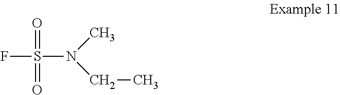

wherein:
R₃ is annularly connected with R₄ and R₆ is annularly connected with R₇ by covalent bond represented by connecting the end “-” from the above Structures 2 and 3, respectively;
each of R₃, R₄, R₆, and R₇ can be any one of:
   CF₂—;
   —CH₂—:
   —CH((CH₂)ₓH_{1-y}F_{y})— (x=0 to 3, y=0 to 1);
   —CF((CH₂)ₓH_{1-y}F_{y})— (x=0 to 3, y=0 to 1); and
   —CH((CH₂₋ₓFₓ)CH═CH_{1-z}F_{z}(CH_{2-x′}f_{x′})ᵥH_{1-w}F_{w})— (x=0 to 2, x′=0 to 2, y=0 to 2, z=0 to 1, v=0 to 2, w=0 to 1);
R₃ R₄ or R₃ R₄;
R₆≠R₇ or R₆=R₇; and
each of R₅ and R₈ can be any one of:
   —(CH₂)ₓCH₃ (x=0 to 3); and
   —(CH₂)ₓCH═CH₂ (x=1 to 3).

Without limitation, following are example sulfonyl-based solvents having general Structure 2 or general Structure 3: 1) R₃/R₆ is —CH₂—, R₄/R₇ is —CH₂—, R₅/R₈ is —CH₃, and the solvent is —CH₂SO₂N(CH₃)(SO₂CH₂—); 2) R₃/R₆ is —CF₂—, R₄/R₇ is —CF₂—, R₅/R₈ is —CH₂CH═CH₂, and the solvent is —CF₂SO₂N (CH₂CH═CH₂)(CF₂)—; 3) R₃/R₆ is —CH(CH═CH₂F)—, R₄/R₇ is —CH(CH═CH₂)—, R₅/R₈ is —CH₃, and the solvent is —(FCH₂=CH)CHSO₂N(CH₃)CH(CH═CH₂)—; 4) R₃/R₆ is —CH₂—, R₄/R₇ is —CH₂CH₂—, R₅/R₈ is —CH₃, and the solvent is —CH₂SO₂N(CH₃)CH₂CH₂—; 5) R₃/R₆ is —CH₂CH₂—, R₄/R₇ is —CH₂CH₂—, R₅/R₈ is —CH₂CH₃, and the solvent is —CH₂CH₂SO₂N(CH₂CH₃)CH₂CH₂—; and 6) R₃/R₆ is —CF₂—, R₄/R₇ is CF₂, R₅/R₈ is CH₃, and the solvent is —CF₂SO₂N(CH₃)SO₂CF₂—.

Example structures of the foregoing examples of Structure 2:

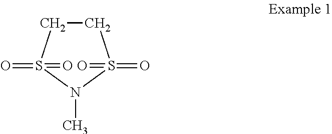

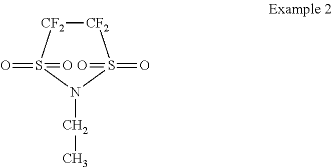

Example structures of the foregoing examples of Structure 3:

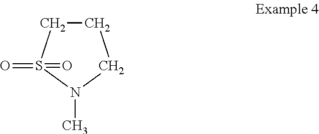

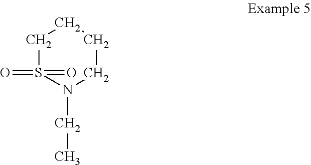

Structure 4:

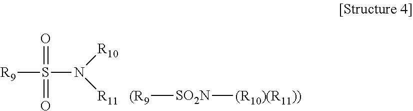

wherein:
R₉ can be —(CH₂)ₓ(CH_{2-y}F_{y})F (x=0 to 2, y=0 to 2, z=0 to 2);
R₁₀ can be —(CH₂)ₓO(CH₂)_{y}CH₃ (x=2 to 4, y=0 to 2); and
R₁₁ u can be:
   —(CH₂)ₓCH₃ (x=0 to 3); or
   —(CH₂)ₓ0(CH₂)_{y}CH₃ (x=2 to 4, y=0 to 2).

Without limitation, following are example sulfonyl-based solvents having general Structure 4: 1) R₉ is —F, R₁₀ is —(CH₂)₂OCH₃, R₁₁ is —(CH₂)₂OCH₃, and the solvent is FSO₂N[(CH₂)₂OCH₃]₂; 2) R₉ is —F, R₁₀ is —(CH₂)₂OCH₃, R₁₁ is —CH₃, and the solvent is FSO₂N[(CH₂)₂OCH₃][CH₃]; 3) R₉ is —CF₃, R₁₀ is —(CH₂)₂OCH₃, R₁₁ is —(CH₂)₂OCH₃, and the solvent is CF₃SO₂N[(CH₂)₂OCH₃]₂; and 4) R₉ is —CF₃, R₁₀ is —(CH₂)₂OCH₃, R₁₁ is —CH₃, and solvent is CF₃SO₂N[(CH₂)₂OCH₃][CH₃].

Example structures of the foregoing examples of Structure 4:

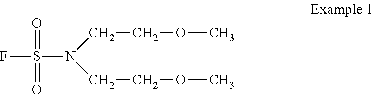

Structure 5:

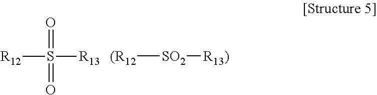

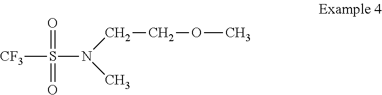

wherein:
within R₁₃ is a N-containing, an O-containing,
   an only-hydrocarbon-containing, or a N+O—
   mixture-containing ring structure;
R₁₂ can be —(CH₂)ₓ(CH_{2-y}F_{y})F (x=0 to 2, y=0 to 2, z=0 to 2);
R₁₃ can be:
   —N(CH₂)₄ (1-pyrrolidino five-membered ring);
   —N(CH₂)₅ (1-piperidinyl six-membered ring);
   —N(CH₂CH₂)₂O (4-morpholinyl six-membered ring);
   —C₅H₉ (cyclopentane);
   —C₆H₁₁ (cyclohexane);
   —C₄H₇O (2 or 3-tetrahydrofuran); or
   a fluorinated analog thereof.

Without limitation, following are example sulfonyl-based solvents having general Structure 5: 1) R₁₂ is —F, R₁₃ is —N(CH₂)₄, and the solvent is FSO₂N(CH₂)₄ (five-membered ring); 2) R₁₂ is —CF 3, R₁₃ is —N(CH₂)₄ (five-membered ring), and the solvent is CF₃SO₂N(CH₂)₄ (five-membered ring); 3) R₁₂ is —F, R₁₃ is —N(CH₂CH₂)₂O (six-membered ring), and the solvent is FSO₂N(CH₂CH₂)₂O (six-membered ring).

Example structures of the foregoing examples of Structure 5:

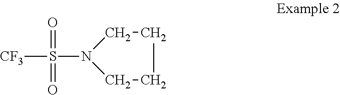 [SMILES: O=S(=O)(N1CCCC1)C(F)(F)F]

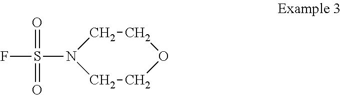

A sulfonyl-based solvent system of the present disclosure and/or a sulfonyl-based electrolyte of the present disclosure may contain a single type of the sulfonyl-based solvents of the present disclosure or a mixture of two or more types of the sulfonyl-based solvents disclosed herein, including both linear sulfonyl-based solvents and cyclic sulfonyl-based solvents, with each solvent ranging, for example, from about 100% to about 0.05% by volume ratio, by weight ratio, or by mole ratio, or in a range of about 5% to about 50% by volume ratio, by weight ratio, or by mole ratio. If the sulfonyl-based solvent system or sulfonyl-based electrolyte contain only a single solvent, then Structure 1 does not include R₁ and R₂ being —N(CH₃)₂ in combination with either —F or —CF 3 .

In addition, a sulfonyl-bases solvent system and an electrolyte of the present disclosure may also contain one or more types of solvents other than a sulfonyl-based solvent, or “non-sulfonyl-based solvent”, mixed with the sulfonyl-based solvent(s). Examples of non-sulfonyl-based solvents that can be used in a sulfonyl-based solvent system and sulfonyl-based electrolyte of the present disclosure include, but are not limited to, carbonates, ethers, nitriles, phosphates, sulfonates, sultones, and sulfates, either cyclic or linear, non-fluorinated or fluorinated, with each solvent in the sulfonyl-based solvent system ranging for example, from about 100% to about 0.05% by volume ratio, by weight ratio, or by mole ratio, or in a range of about 5% to about 50% by volume ratio, by weight ratio, or by mole ratio.

In some embodiments, one or more of the following salts can be combined with any one of the above newly discovered sulfonyl-based solvent systems to form sulfonyl-based electrolyte of the present disclosure: LiFSI, LiTFSI, LiClO₄, LiBF₄, LiPF₆, LiAsF₆, LiTF, LiBETI, LiCTFSI, LiTDI, LiPDI, LiDCTA, LiB(CN)₄, LiBOB, LiDFOB, among others, in a concentration ranging from about 0.1 M up to about 5.5 M, inclusive. It is noted that while the foregoing example salts are lithium-based, the Li cations in these salts can be replaced by other cations, such as Na, Mg, K, and Zn, among others. In some embodiments, a concentration of the salt(s) in a range of about 0.9 M to about 3.5 M can be preferred. For example, when LiFSI salt and EMSF solvent are selected, an example preferred range is about 2.0 M to about 3.0 M, when LiFSI salt and DSF/EMSF hybrid solvent are selected, and example preferred range is about 2.5 M to about 3.5 M, and when LiFSI salt and DSF/ethylene glycol diethyl ether (DEE) solvent are selected, an example preferred range is about 2.5 M to about 4.5 M. It is noted that while the foregoing salts are all lithium-based, salts of one or more other alkali metal, such as sodium or potassium, can be used with a sulfonyl-based solvent system of this disclosure according to the chemistry of the particular sulfonyl-based electrolyte at issue. It is also noted that sulfonyl-based solvent systems of the present disclosure may be suitable for Li-ion cells and batteries. In some examples for Li-ion cells and batteries, the salt-solvent mole ratio may be in a range of about 1:7 to about 1:1. For example, when LiFSI salt and bis(2-methoxyethyl) sulfamoyl fluoride (BMSF) solvent are used, the molarity of the LiFSI salt can be about 5.5 M per 1 L of solvent, with the corresponding LiFSI:BMSF mole ratio being about 1:1.

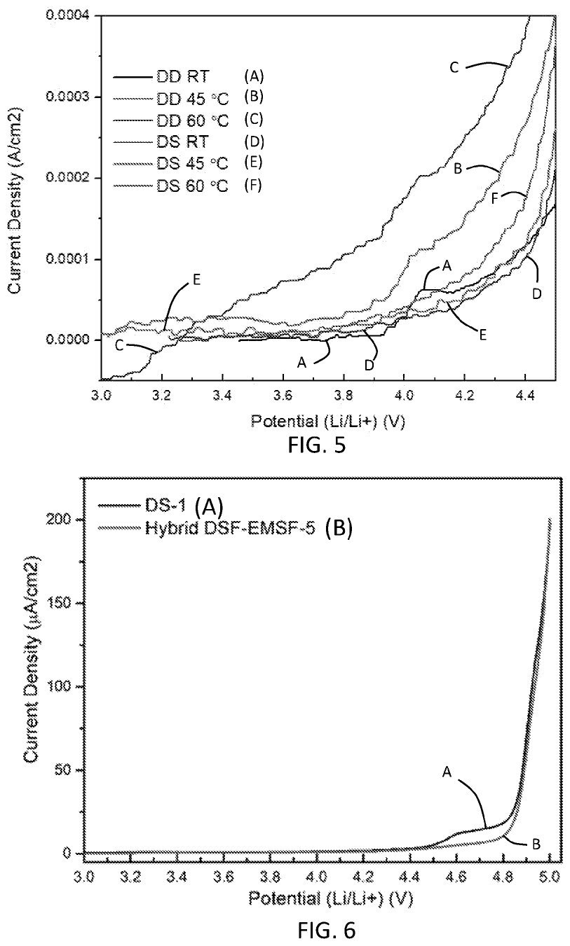

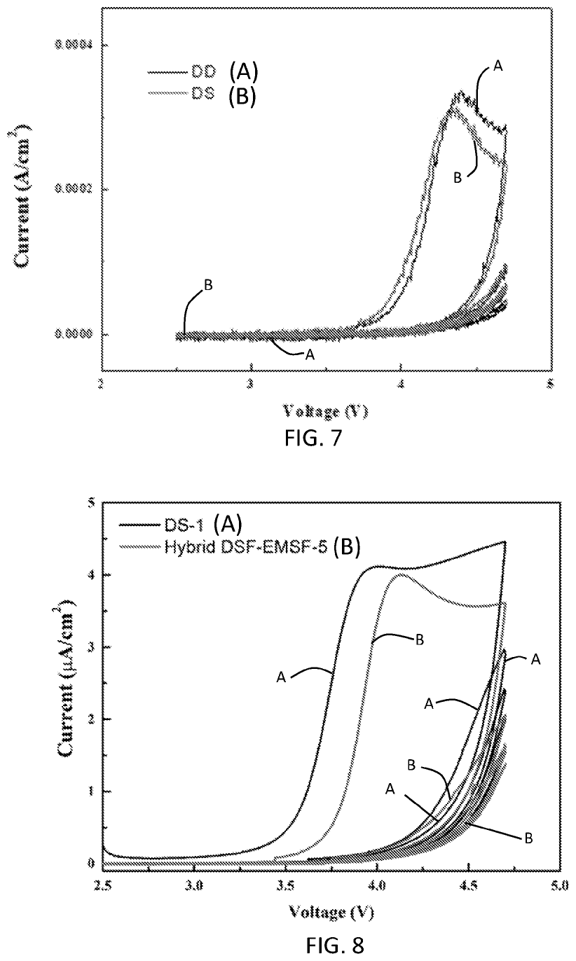

Merits of the discovered sulfonyl-based electrolytes disclosed herein can include the following:
1) The new sulfonyl-based electrolytes can promote the formation of a robust and protective passivation layer on Li surface as well as have high stability towards Li metal anode and high coulombic efficiency (FIG. 1, new hybrid sulfonyl-based electrolytes gave high CE value (99.65%) and long-lasting cycles).
2) Disclosed ones of the sulfonyl-based electrolytes provide beneficial synergistic effect to improve cycling stability and lower direct-current internal resistance (DCIR) (75% of DCIR value based on the single DSF-containing electrolyte after 100 cycles) of total cells during cycles (FIG. 2).
3) Disclosed ones of the sulfonyl-based electrolytes behave well, can have good oxidative stability at high voltage in a wide temperature range, which greatly minimizes solvent decomposition at high voltage on the cathode surface. FIG. 5 is a linear-sweep voltammetry (LSV) scan plot for a conventional ether-based electrolyte (3.97M LiFSI in 1,4-dioxane (DX) and DEE in a ratio of 1:5.1 v:v+30% TFE; “DD”) and a sulfonyl-based electrolyte (2.5 M LiFSI in DSF; “DS”). The LSV was performed with a platinum electrode at room temperature (˜20° C.), 45° C., and 60° C. As seen in FIG. 5, the “DS” electrolyte exhibited a significantly lower oxidative current density at higher temperatures and higher voltages than the conventional “DD” electrolyte. In addition, it was demonstrated, as seen in the LSV scan plot of FIG. 6 (platinum electrode at 30° C.), that a hybrid sulfonyl-based electrolyte (“Hybrid DSF-EMSF-5” (see the TABLE above)) of the present disclosure had superior oxidative stability than a single DSF-containing electrolyte (“DS-1” (see the TABLE above).
4) Both the “DD” and “DS” electrolytes of FIG. 5 also have no aluminum corrosion issue (see the cyclic voltammetry (CV) plot of FIG. 7 with an aluminum electrode). Surprisingly, it was observed that a hybrid sulfonyl-based electrolyte (here, “Hybrid DSF-EMSF-5” (see the TABLE above)) of the present disclosure can passivate the aluminum electrode surface faster when compared to the single-DSF “DS-1” electrolyte (see FIG. 8).
5) Ones of the sulfonyl-based electrolytes of the present disclosure can exhibit good thermal stability and processability due to having a relatively high boiling point (e.g., >150° C.).
6) Ones of the sulfonyl-based electrolytes of the present disclosure can have a relatively low cost because of the decrease in salt molarity when using a sulfonyl-based solvent system of the present disclosure in which at least one of the sulfonyl-based solvents has a molecular mass larger than the molecular mass of DSF.
7) Ones of the sulfonyl-based electrolytes of the present disclosure can have low or no flammability, which allows them to meet higher safety requirements when considering highly flammable carbonate-based conventional electrolytes widely used in Li-ion battery today.

Embodiments of this disclosure include the individual sulfonyl-based solvents and sulfonyl-based solvent systems described above, as well as mixtures of such solvents with one another, including, but not limited to, the specific mixtures noted above. Embodiments of this disclosure also include sulfonyl-based electrolytes each made using any one or more of the sulfonyl-based solvent systems described above, including any example mixtures, and one or more salts, including the lithium-based salts enumerated above and/or mixture thereof, and any salt or mixture thereof based on an alkali metal other than lithium, such as sodium or potassium. Embodiments of this disclosure further include electrochemical devices, such as batteries and super capacitors, that each contain an electrolyte made in accordance with aspects of this disclosure. Example batteries include LMB, lithium-ion batteries, and batteries based on an alkali metal other than lithium, such as sodium-metal batteries or potassium-metal batteries, among others. Those skilled in the art understand the many differing constructions of electrochemical devices that can utilize an electrolyte made in accordance with the present disclosure, and all suitable ones of such conventional electrochemical-device constructions are incorporated herein as a basis for electrochemical devices made in accordance with the present disclosure, including such conventionally constructed electrochemical devices containing a sulfonyl-based electrolyte (and sulfonyl-based solvent(s)) made in accordance with the present disclosure.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An electrolyte for an electrochemical device having an alkali-metal anode having an anode-active material comprising an alkali metal, the electrolyte comprising:
a sulfonyl-based solvent system comprising one or more sulfonyl-based solvents, each having one of the following general molecular structures:
Structure 1: R₁—SO₂—R₂, wherein:
each of R₁ and R₂ is any one of:
—F;
—CF₃;
—N(SO₂F)₂;
—N(CH₃)SO₂F, —N[(CH₂)ₓCH₃)][(CH₂) 5 ,CH₃)] (x=0 to 3, y=0 to 3);
—N[(CH₂)ₓCH₃][(CH₂)_{y}CH═CH(CH₂)_{z}—H] (x=0 to 2; y=1 to 3, z=0 to 3);
—(CH₂)ₓCH═CH(CH₂)_{y}—H (x=0 to 3; y=0 to 3);
—C₆H₅₋ₓFₓ (x=0 to 5);
—(CH₂)ₓ(CH_{2-y}F_{y})_{z}CH_{3-w}F_{w} (x=0 to 2, y=1 to 2, z=0 to 2, w=0 to 3);
—(CH₂)ₓ(CH_{2-y}F_{y})_{z}F (x=0 to 2, y=0 to 2, z=0 to 2); and
—(CH₂)ₓCH═CH(CH₂-yF_{y})_{z}F (x=0 to 3, y=0 to 2, z=0 to 2); and
R₁ R₂ or R₁=R₂;
Structure 2: —R₃—SO₂N—R₅SO₂—R₄—, wherein:
each of R₃ and R₄ is any one of:
—CF₂—;
—CH₂—:
—CH((CH₂)ₓH_{1-y}F_{y})— (x=0 to 3, y=0 to 1);
—CF((CH₂)ₓH_{1-y}F_{y})— (x=0 to 3, y=0 to 1); and
—CH((CH₂₋ₓFₓ)_{y}CH═CH_{1-z}F_{z}(CH_{2-x′}F_{x′})ᵥH_{1-w}F_{w})— (x=0 to 2, x′=0 to 2, y=0 to 2, z=0 to 1, v=0 to 2, w=0 to 1);
R₃≠R₄ or R₃=R₄; and
R₅ is any one of:
—(CH₂)ₓCH₃ (x=0 to 3); and
—(CH₂)ₓCH═CH₂ (x=1 to 3);
Structure 3: —R₆-SO₂N—(Rg)R₇—, wherein:
each of R₆ and R₇ is any one of:
—CF₂—;
—CH₂—:
—CH((CH₂)ₓH_{1-y}F_{y})— (x=0 to 3, y=0 to 1);
—CF((CH₂)ₓH_{1-y}F_{y})— (x=0 to 3, y=0 to 1); and
—CH((CH₂₋ₓFₓ)_{y}CH═CH_{1-z}F_{z}(CH_{2-x′}F_{x′})ᵥH_{1-w}F_{w})— (x=0 to 2, x′=0 to 2, y=0 to 2, z=0 to 1, v=0 to 2, w=0 to 1);
R₆≠R₇ or R₆=R₇; and
R₈ can be any one of:
—(CH₂)ₓCH₃ (x=0 to 3); and
—(CH₂)ₓCH═CH₂ (x=1 to 3);
Structure 4: R₉—SO₂N—(R₁₀)(R₁₁), wherein:
R₉ is —(CH₂)ₓ(CH_{2-y}F_{y})_{z}F (x=0 to 2, y=0 to 2, z=0 to 2);
R₁₀ is —(CH₂)ₓO(CH₂)_{y}CH₃ (x=2 to 4, y=0 to 2); and
R₁₁ is any one of:
—(CH₂)ₓCH₃ (x=0 to 3); and
—(CH₂)ₓO(CH₂)_{y}CH₃ (x=2 to 4, y=0 to 2); and
Structure 5: R₁₂—SO₂—R₁₃, wherein:
within R₁₃ is a nitrogen (N)-containing, an oxygen (O)-containing, an only-hydrocarbon-containing, or an (N+O)-mixture-containing ring structure;
R₁₂ is —(CH₂)ₓ(CH_{2-y}F_{y})_{z}F (x=0 to 2, y=0 to 2, z=0 to 2);
R₁₃ is any one of:
—N(CH₂)₄ (1-pyrrolidino five membered ring);
—N(CH₂)₅ (1-piperidinyl six-membered ring);
—N(CH₂CH₂)₂O (4-morpholinyl six-membered ring);
—C₅H₉ (cyclopentane);
—C₆H₁₁ (cyclohexane);
—C₄H₇O (2 or 3-tetrahydrofuran); and
a fluorinated analog thereof; and
at least one alkali-metal salt dissolved in the one or more sulfonyl-based solvents, the alkali-metal salt having a cation comprising the alkali metal of the anode-active material;
wherein, when the electrolyte contains a single solvent and the single solvent has Structure 1, Structure 1 does not include R₁ and R₂ being —N(CH₃)₂ in combination with either —F or —CF₃.

2. The electrolyte of claim 1, wherein the electrolyte further comprises at least one non-sulfonyl-based solvent.

3. The electrolyte of claim 1, wherein the electrolyte includes only a single one of the sulfonyl-based solvents.

4. The electrolyte of claim 3, wherein the single sulfonyl-based solvent has a general molecular structure selected from the group consisting of Structure 2, Structure 3, Structure 4, and Structure 5.

5. The electrolyte of claim 1, wherein the electrolyte includes two or more of the sulfonyl-based solvents.

6. The electrolyte of claim 5, wherein the electrolyte further includes at least one non-sulfonyl-based solvent.

7. The electrolyte of claim 1, wherein at least one of the sulfonyl-based solvents has Structure 1 and is selected from the group consisting of: CH₂=CHSO₂F; CH₂=CHSO₂CF₃; (CH₃)₂NSO₂F; FSO₂N(CH₃)SO₂F; (CH₃)(CH₂=CHCH₂)NSO₂N(CH₃)₂; CH₃CH═CHSO₂N(CH₃)(CH₂CH₃); C₆H₄FSO₂CH₂CF₃; FCH₂SO₂CH═CHCH₂F; CH₂FCH═CHCF₂SO₂N(SO₂F)₂; C₆H₅SO₂F; FSO₂N(CH₃)(CH₂CH₃); FSO₂N(CH₂CH₃)₂; and CF₃SO₂F.

8. The electrolyte of claim 1, wherein at least one of the sulfonyl-based solvents has Structure 2 or Structure 3.

9. The electrolyte of claim 8, wherein the at least one sulfonyl-based solvents is selected from the group consisting of: —CH₂SO₂N(CH₃)(SO₂CH₂—); —CF₂SO₂N(CH₂CH═CH₂)(CF₂)—; —(FCH₂=CH)CHSO₂N(CH₃)CH(CH═CH₂)—; and —CF₂SO₂N(CH₃)SO₂CF₂—.

10. The electrolyte of claim 1, wherein at least one of the sulfonyl-based solvents has Structure 4.

11. The electrolyte of claim 10, wherein the at least one of sulfonyl-based solvents is selected from the group consisting of: FSO₂N[(CH₂)₂OCH₃]₂; FSO₂N[(CH₂)₂OCH₃][CH₃]; CF₃SO₂N[(CH₂)₂OCH₃]₂; and CF₃SO₂N[(CH₂)₂OCH₃][CH₃].

12. The electrolyte of claim 1, wherein at least one of the sulfonyl-based solvents has Structure 5.

13. The electrolyte of claim 12, wherein the at least one sulfonyl-based solvents is selected from the group consisting of: FSO₂N(CH₂)₄ (five-membered ring); CF₃SO₂N(CH₂)₄ (five-membered ring); and FSO₂N(CH₂CH₂)₂O (six-membered ring).

14. The electrolyte of claim 1, wherein the electrochemical device comprises a lithium-metal battery having a lithium-metal anode, and the at least one alkali-metal salt comprises at least one lithium salt.

15. The electrolyte of claim 14, wherein the at least one lithium salt is selected from the group consisting of LiFSI, LiTFSI, LiClO₄, LiBF₄, LiPF₆, LiAsF₆, LiTF, LiBETI, LiCTFSI, LiTDI, LiPDI, LiDCTA, LiB(CN)₄, LiBOB, and LiDFOB.

16. The electrolyte of claim 15, wherein the at least one lithium salt is LiFSI, and the sulfonyl-based solvent system comprises N-ethyl, N-methyl sulfamoyl fluoride (EMSF).

17. The electrolyte of claim 16, wherein the sulfonyl-based solvent system comprises EMSF in combination with N,N-dimethylsulfamoyl fluoride (DSF).

18. The electrolyte of claim 17, wherein the sulfonyl-based solvent system has a DSF:EMSF percentage ratio by each of volume, weight, and mole in a range of about 5:95 to about 95:5.

19. The electrolyte of claim 18, wherein the sulfonyl-based solvent system has a DSF:EMSF percentage ratio by each of volume, weight, and mole in a range of about 50:50 to about 95:5.

20. The electrolyte of claim 17, wherein the LiFSI has a concentration in the sulfonyl-based solvent system in a range of about 0.1 M to about 5.5 M.

21. The electrolyte of claim 20, wherein the concentration is in a range of about 0.9 M to about 3.5 M.

22. The electrolyte of claim 21, wherein the sulfonyl-based solvent system consists essentially of the DSF and the EMSF, and the LiFSI has a concentration in a range of about 2.5 M to about 3.5 M.

23. The electrolyte of claim 16, wherein the at least one lithium salt is LiFSI, the sulfonyl-based solvent system consists essentially of the EMSF, and the LiFSI has a concentration in the EMSF in a range of about 2.0 M to about 3.0 M.

24. The electrolyte of claim 15, wherein the at least one lithium salt is LiFSI, and the sulfonyl-based solvent system comprises diethylsulfamoyl fluoride (DESF).

25. The electrolyte of claim 15, wherein the sulfonyl-based solvent system comprises bis(2-methoxyethyl) sulfamoyl fluoride (BMSF).

26. The electrolyte of claim 25, wherein the sulfonyl-based solvent system consists essentially of the BMSF and the at least one lithium salt is LiFSI, wherein the LiFSI has a concentration of about 5.5 M per liter of the BMSF.

27. The electrolyte of claim 15, wherein the sulfonyl-based solvent system comprises N,N-dimethylsulfamoyl fluoride (DSF) and ethylene glycol diethyl ether (DEE).

28. The electrolyte of claim 27, wherein the at least one lithium salt is LiFSI, the sulfonyl-based solvent system consists essentially of the DSF and the DEE, and the LiFSI has a concentration in a range of about 2.5 M to about 4.5 M.

29-58. (canceled)
